(19) United States
(12) Patent Application Publication
(10) Pub. No.: US 2003/0110906 A1
(43) Pub. Date: Jun. 19, 2003

(54) Versatile tubular holder for positioning and operating the hex wrenchs

(76) Inventors: Hsin-Hung Li, Feng-Yuan City (TW); Chen-Ta Lin, Feng-Yuan City (TW)

Correspondence Address: HSIN-HUNG LI, P.O. Box 697, Feng-Yuan City, 420, TW

(21) Appl. No.: 10/020,879

(22) Filed: Dec. 19, 2001

(51) Int. Cl. B25B 23/16

(52) U.S. Cl. 81/177.1

(57) ABSTRACT

A versatile tubular holder for positioning and operating the hex wrenchs includes a tubular holder having a closed end, an open end, a plurality of circular positioning holes of different diameters spacedly formed in the closed end extending along the length of the lateral walls of the holder, a hollow interior extension projected downward from a middle portion of the holder including a plurality of different sized hexagon inserting holes centrally and spacedly formed in one of the lateral sides extending along the length thereof and an opening abutting a pair of stepped inner wall in the other side opposite to the hexagon inserting holes. It is characterized that a plurality of l-shaped hex wrenchs position their tails into the circular positioning holes respectively when not in use and insert their head into the hexagon inserting holes respectively in operation.

### BACKGROUND OF THE INVENTION

The present invention relates to wrenchs and more particularly to a versatile tubular holder for positioning and operating the hex wrenchs.

Conventionally, the hex wrenches are positioned on a plate in a row which occupies a great space. Latterly, a tubular holder is provided to position the wrenchs (as shown in FIGS. 1 and 2) which includes a tubular holder 10 and a plurality of positioning slots 12 into which a hex wrench 11 is positioned (as shown in the dash lines in FIG. 2). In use, take off the wrench 11 and engage the head 111 into the positioning slot 12. The tubular holder 10 therefor became a handle to operate the hex wrench 11. The holder 10 is made of plastic material. The slots 12 each has a half opening portion and a half closed potion. The torque is partially provided by the closed portion and partially by the opening portion and especially concentrated on the lateral walls of the opening portion which causes the oscillation of the wrench and is hardly provided adequate torque.

### SUMMARY OF THE PRESENT INVENTION

The present invention has a main object to provide a versatile tubular holder for positioning and operating the hex wrenchs which provides a variety of different positioning holes and insertion holes to receive different size of hex wrenchs and provides adequate torque to the hex wrenches during operation.

Accordingly, the versatile tubular holder for positioning and operating the hex wrenchs of the present invention comprises a tubular holder of roughly U-shaped section, a plurality of annular positioning holes in different size spacedly formed through the lateral walls of the holder and an insertion extension projected downward of the tubular holder in which a plurality of hexagon insertion holes of different sized spacedly and centrally formed in one side and a hexagon opening in the other side. By this, the largest hex wrench inserts into a largest hexagon insertion hole inside the walls of the U-shaped holder. The middle hex wrench inserts into a middle sized hexagon insertion hole in the upper portion of the insertion extension and smallest hex wrench inserts into a smallest hexagon insertion hole. So that both the hex wrenchs are provided adequate torque forces.

The present invention will become more fully understood by reference to the following detailed description thereof when read in conjunction with the attached drawings.

### BRIEF DESCRIPTION OF THE DRAWINGS

FIG. 1 is a perspective of a tubular holder according to a prior art,

FIG. 2 is a sectional view of FIG. 1 to positioning and operating a hex wrench,

FIG. 3 is an exploded perspective to show a versatile tubular holder for positioning and operating the hex wrenchs according to the preferred embodiment of the present invention,

FIG. 4 is an exploded perspective view looking from other end of the tubular holder,

FIG. 5 is a perspective view to show that a hex wrench is positioning into the positioning hole (in dash line) and/or engaged into a inserting hole (solid line),

FIG. 6 is a vertical plane view looking from one end of the tubular holder,

FIG. 7 is a sectional view of FIG. 5, and

FIG. 8 is a sectional view to show a small hex wrench engaged into a small inserting hole of the tubular holder.

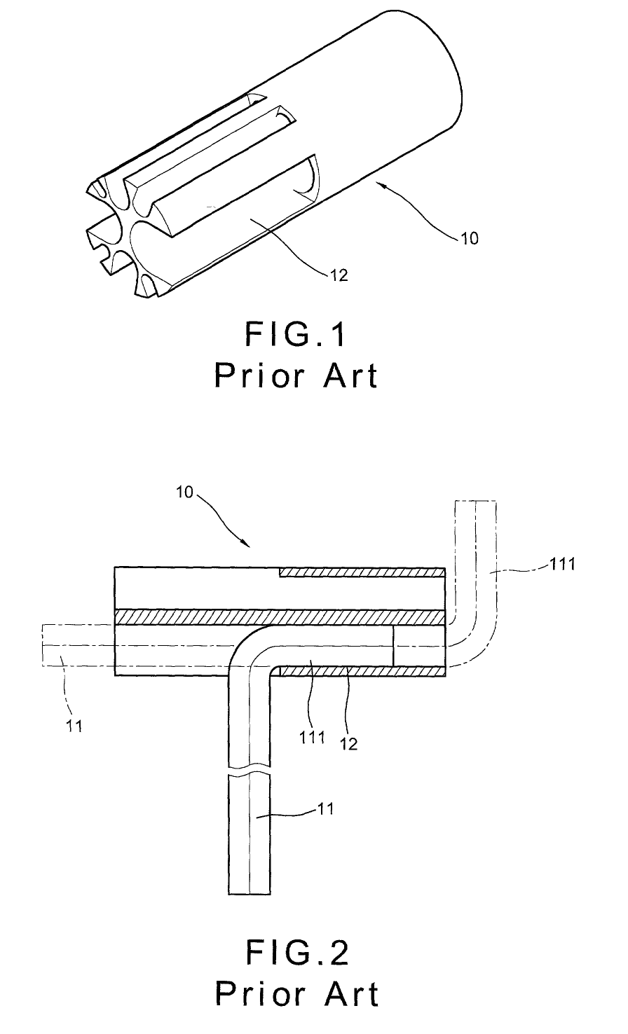

### DETAILED DESCRIPTION OF THE PREFERRED EMBODIMENT

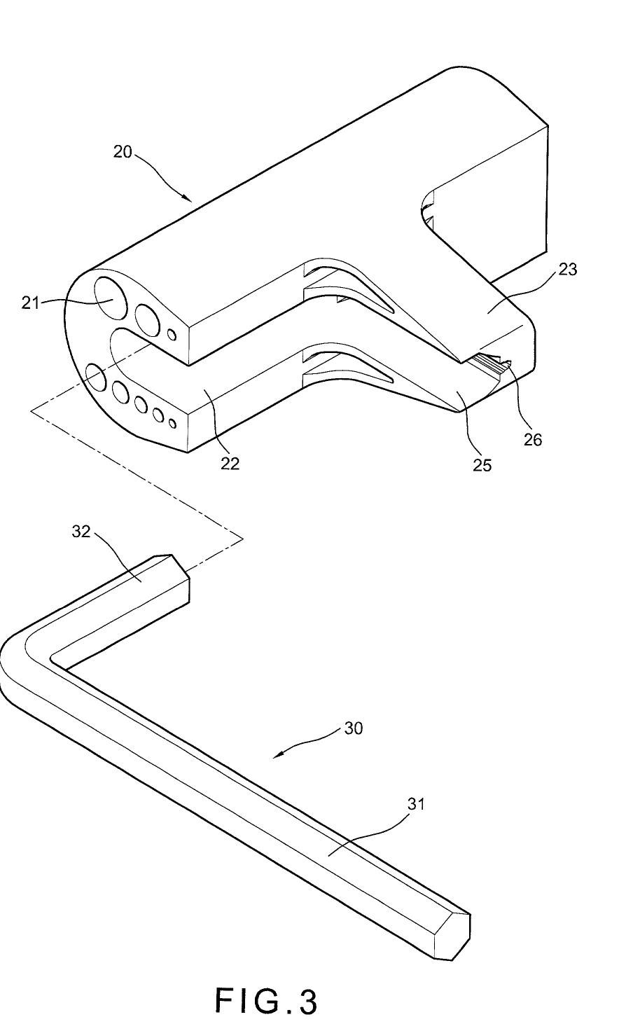

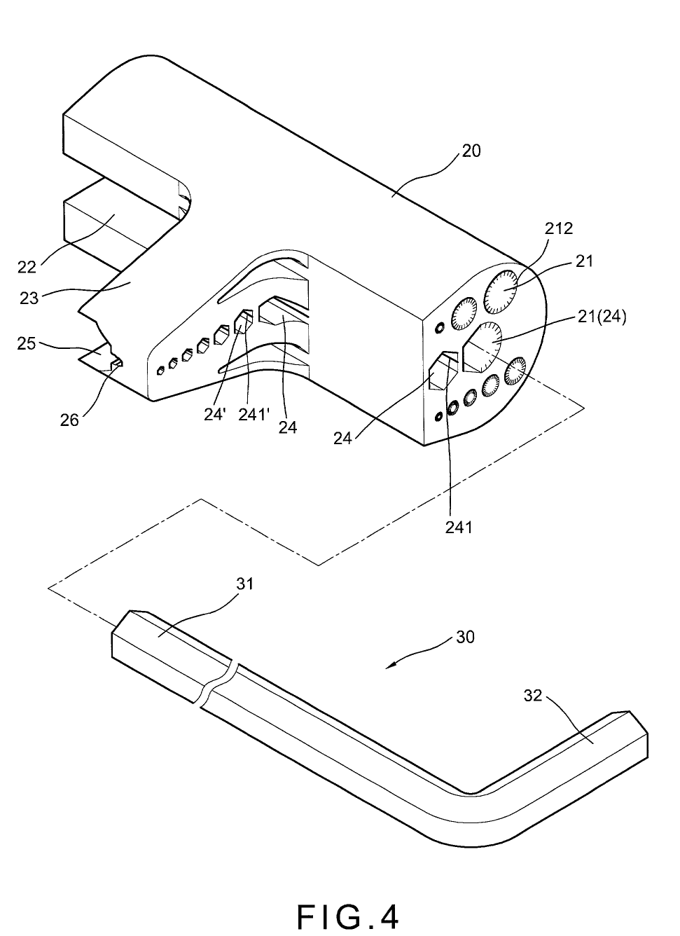

With reference to FIGS. 3 and 4 of the drawings, the versatile tubular holder for positioning and operating the hex wrenchs of the present invention comprises generally a versatile tubular holder 20 and a L-shaped hex wrench 30 which may be phial.

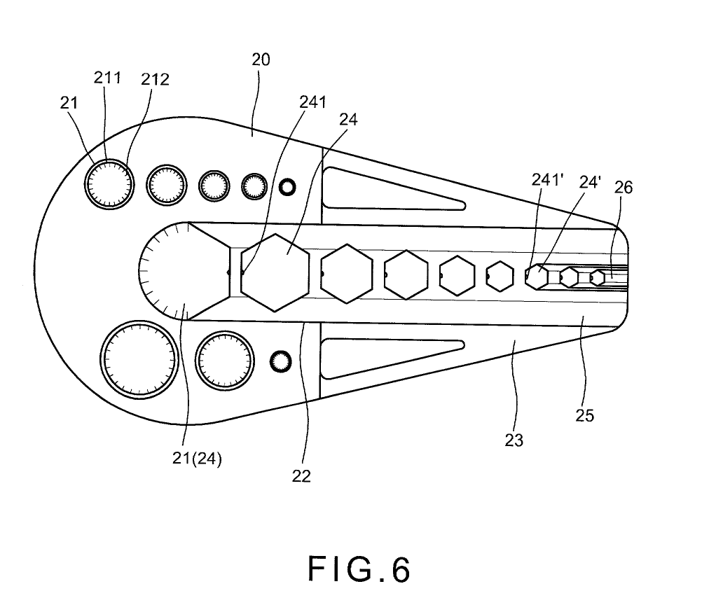

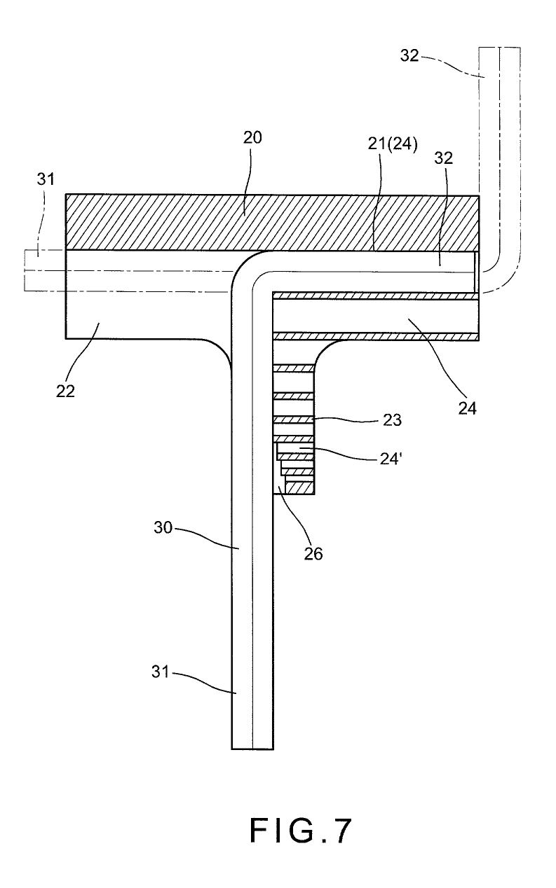

The versatile tubular holder 20 is a housing of U-shaped section and has a plurality of circular positioning holes 21 of different diameters spacedly formed and axially through the lateral wall 22 of the housing. Each of the circular positioning holes 21 has a rim 211 and a plurality of points 212 on inner wall (as show in FIG. 6). In the closed end of the housing, there is an extra large positioning hole 21 (24) which is half circular and half hexagonal and a largest hexagon inserting hole 24 centrally formed in lower portion. The largest hexagon inserting hole has a spline 241 on an inner wall along the length thereof. An hollow interior extension 23 is projected downward from the housing and has a plurality of hexagon inserting holes 24′ of different sizes spacedly and centrally formed in one of the lateral sides extending along the length thereof which can serve different sizes of the L-shaped hex wrenchs 30 and each has a spline 241′ on an inner wall extending along the length thereof wherein, the three smaller hexagon inserting holes 24′ in the lower portion of the extension 23 are shallower than the three larger ones above them (as shown in FIG. 7). On the other side of the extension 23, there is an opening 25 which engages with the large sized L-shaped hex wrenchs 30 and a stepped inner walls 26 for engaging with the small sized L-shaped hex wrenchs 30. Further, the space inside the U-shaped housing may receive a largest L-shaped hex wrench 30 together with the largest hexagon inserting hole 24.

The L-shaped hex wrench 30 has a head 32 and a tail 31. The head 32 is inserted into the hexagon inserting hole 21 in operation and the tail 31 is inserted into the circular positioning hole when not in use. Actually, the hex wrench is plural in number and different in size.

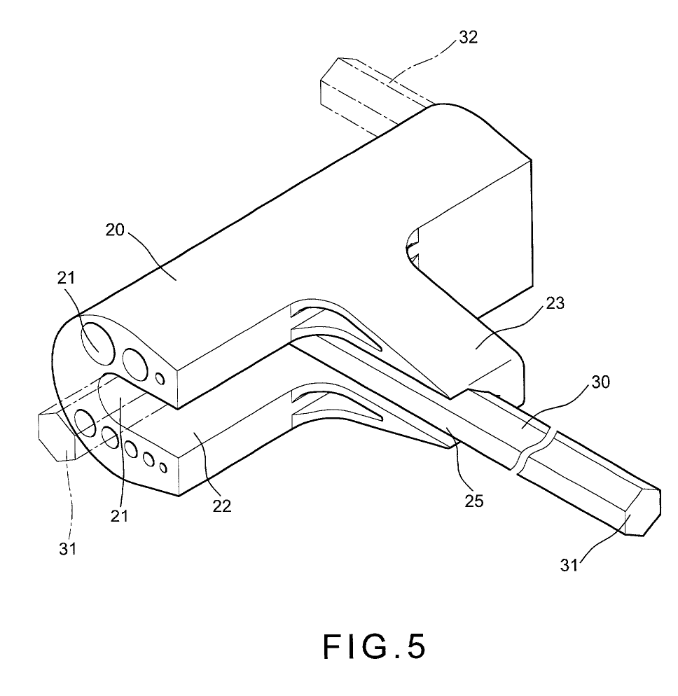

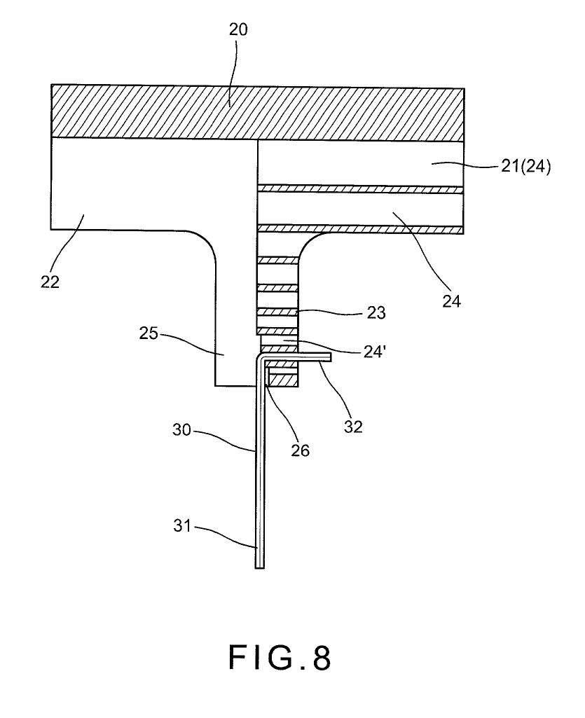

Referring to FIGS. 5 to 8, when not in use, the tails 31 of different sized L-shaped hex wrenchs 30 are inserted into the different sized circular positioning holes 21 in regular condition (as shown in FIGS. 5 and 7). If one of the wrenchs 30 is in need of draw it out of the housing and insert the head 32 of it into a suitable hexagon inserting hole 24 of the extension 23. This time, the holder 10 becomes a handle to operate the wrench 30 to drive a working piece. If the largest sized hex wrench 30 is used, Both the walls 22 of the U-shaped housing and the opening 25 of the extension 23 can provide adequate torque, and if a smallest sized hex wrench 30 is used, the stepped inner walls 26 can provide adequate torque (as shown in FIG. 8). This arrangement insures that the tubular holder 10 can serve a plurality of different sized L-shaped hex wrenchs and each of the different sized hex wrenchs is provide proper torque force to finish their jobs.

Note that the specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A versatile tubular holder for positioning and operating the hex wrenchs comprising:
a tubular holder having a U-shaped housing, a closed end, an open end, a pair of lateral walls, a plurality of circular positioning holes of different diameters spacedly formed and axially through the walls along the length thereof and each having a rim and a plurality of pints spacedly formed on inner wall, a largest half circular and half hexagonal positioning hole centrally formed in the closed end communicating to inside of the housing and a largest hexagon inserting hole formed in the closed end beneath the largest positioning hole and extending into the housing including a spline on an inner wall extending along the length thereof;
a hollow interior extension projected downward from a middle portion of the housing having a plurality of different sized hexagon inserting holes spacedly and centrally formed in an alignment in one of lateral sides each including a spline on an inner wall extending along the length thereof and an opening in other side opposite to the alignment of the different sized hexagon inserting holes abutting a pair of stepped walls therein;
a plurality of L-shaped hex wrenchs each having a tail insertible into the different diameter circular positioning holes and a head insertible into the different sized hexagon inserting holes.

2. The versatile tubular holder as recited in claim 1 wherein said tubular holder may be a handle in operation.

3. The versatile tubular holder as recited in claim 1 wherein said hexagon inserting hole in the closed end of said tubular holder is served for a largest sized L-shaped hex wrench.

4. The versatile tubular holder as recited in claim 1 wherein said hexagon inserting holes in the hollow interior extension are served for the middle and smaller sized hex wrenchs.
